(19) United States
(12) Patent Application Publication
(10) Pub. No.: US 2008/0062203 A1
(43) Pub. Date: Mar. 13, 2008

(54) Scalable Vector Graphics Editing Systems and Methods

(76) Inventor: James Williams, Coventry, CT (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/660,909

(22) PCT Filed: Aug. 25, 2005
(86) PCT No.: PCT/US05/30208

§ 371 Date: Oct. 1, 2007

Related U.S. Application Data
(60) Provisional application No. 60/604,016, filed on Aug. 25, 2004.

(51) Int. Cl. G09G 5/00

(52) U.S. Cl. 345/666

(57) ABSTRACT

Methods and systems for the creation and delayed-rendering of scalable vector graphic scenes are disclosed. By creating Techniques for a database containing a plurality of objects with each object being a scalable vector graphic, an editing tool containing a plurality of graphics controls can be used to create a graphic scene using the plurality of scalable vector graphic objects by manipulating a first set of instructions and reference pointers with each reference pointer pointing to a respective scalable vector graphic objects.

### FIELD OF THE INVENTION

This invention relates to methods and systems for creating and displaying scalable vector graphic designs.

### BACKGROUND OF THE INVENTION

As companies provide an ever greater variety of products having increasing complexity to an increasing number of markets, the challenge of managing what is known in industry as “enterprise content” increases. That is, in order to successfully market a particular product, a long list of documents must generated and distributed in a coordinated fashion. For example, in order to successfully sell an automobile, the automobile manufacturer must first generate and distribute a large number of maintenance documents. Further, in order to market the automobile throughout Europe, Asia, Africa and the Americas, the automobile manufacturer must provide the same documentation in a variety of languages.

Another challenge is to assure that each document in every language be appropriately updated. For the example above, should the automobile undergo a mechanical revision, the various changes must be provided in all of the different maintenance manuals as uniformly as possible. Further, to reduce cost of development, the tools required to generate the maintenance manuals should be extremely user friendly to a practicable extent. Accordingly, new technology relating to managing enterprise content is desirable.

### SUMMARY OF THE INVENTION

In one aspect, a computer-based apparatus for creating graphic designs based on a delayed-rendering technique using scalable vector graphics includes a database containing a plurality of objects, each object being a scalable vector graphic, and an editing tool containing a plurality of graphics controls, wherein manipulation of the graphics controls enables the editing tool to create a graphic scene using the plurality of scalable vector graphic objects by manipulating a first set of instructions and reference pointers, each reference pointer pointing to a respective scalable vector graphic objects.

In a second aspect, a method for creating graphic designs based on a delayed-rendering technique using scalable vector graphics includes performing a variety of editing operations using an editing tool containing a plurality of graphics controls, wherein manipulation of the graphics controls enables the editing tool to create a graphic scene using a plurality of scalable vector graphic objects by manipulating a first set of instructions and reference pointers, each reference pointer pointing to a respective scalable vector graphic objects, wherein the plurality of scalable vector graphic objects are located in a database.

In a third aspect, a computer-based apparatus for creating graphic designs based on a delayed-rendering technique using scalable vector graphics includes a database containing a plurality of objects, each object being a scalable vector graphic, and an editing means for editing a graphic scene using a first set of instructions and reference pointers.

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a device for the creation and delayed-rendering of graphic scenes containing scalable vector graphics.

FIG. 2 depicts an exemplary graphic scene.

FIG. 3 is a flowchart outlining an exemplary operation for creating and rendering a scalable vector graphic-based scene.

### DETAILED DESCRIPTION

The particular approach of the disclosed methods and systems includes a variety of novel elements designed to work together in such a way as to produce an improved approach to managing enterprise content having scalable vector graphics. The advantages will become apparent to the reader below, and include (but aren't limited to) the following (in no particular order):

First, rather than incorporate “raw” graphic data directly into a diagram, the disclosed methods and systems incorporate references (a.k.a. “pointers” or “reference pointer”) to graphic objects stored elsewhere. This approach enables the disclosed methods and systems to produce graphic design files having a very small size since little or no actual graphic information need ever be directly incorporated into such design files.

Second, given that reference pointers and not actual graphic data are incorporated into design files, each design file can be updated automatically whenever a constituent graphic object in a library/database is updated.

Third, in various embodiments the disclosed methods and systems lend themselves to open-standards freely available on most computers. For example, from a processing perspective, when the disclosed methods and systems are based upon eXtended Markup Language (XML), a large variety of processing tools, e.g., XML parsers or XML transformation tools such as XSLT, can be used in subsequent processes to perform additional changes or data extractions from the generated graphics.

Fourth, by augmenting the disclosed methods and systems in various embodiments with well-designed language tools, an operator can produce a single graphic design that can be adapted, literally at the push of a button, for any known human language encoded into the graphics objects. For example, after creating a mechanical diagram with a variety of parts and respective labels, the operator can (either during design or after) be assured that, no matter what language is used, the labels will never run into one another or run into a graphic object.

Still another advantage of the disclosed methods and systems is that end-users can independently design various things, such as product labels and maintenance manuals, independently of any ongoing effort to update system libraries with minimal problems. This can both speed document publishing time and make publishing easier to an unskilled operator.

For the purpose of this disclosure the term “graphic symbol” or “graphic object” can refer to a data structure containing actual graphic data, i.e., instructions and/or information necessary to describe a two or three-dimensional geometric shape. The term “graphic database” or “graphic library” can refer to any set of graphic objects commonly stored.

The term “reference pointer”, “reference” and “pointer” can refer to any data item capable of identifying a particular graphic object in a graphic database. For example, a “reference pointer” can be an alphanumeric label, a number in a range of numbers, a memory offset and so on as may be required or otherwise desirable.

A “graphic scene” can be any collection of two or more graphic objects placed within in a definable common viewing area, and a “graphic file” or “design file” can be any file containing a set of at reference pointers and related instructions usable to produce a respective graphic scene. For the purpose of this disclosure, an “instruction” can include things like X-Y coordinate information, angular information, scaling information and any other form of data that might influence the size, shape, position, coloring etc of a graphic object in a graphic scene.

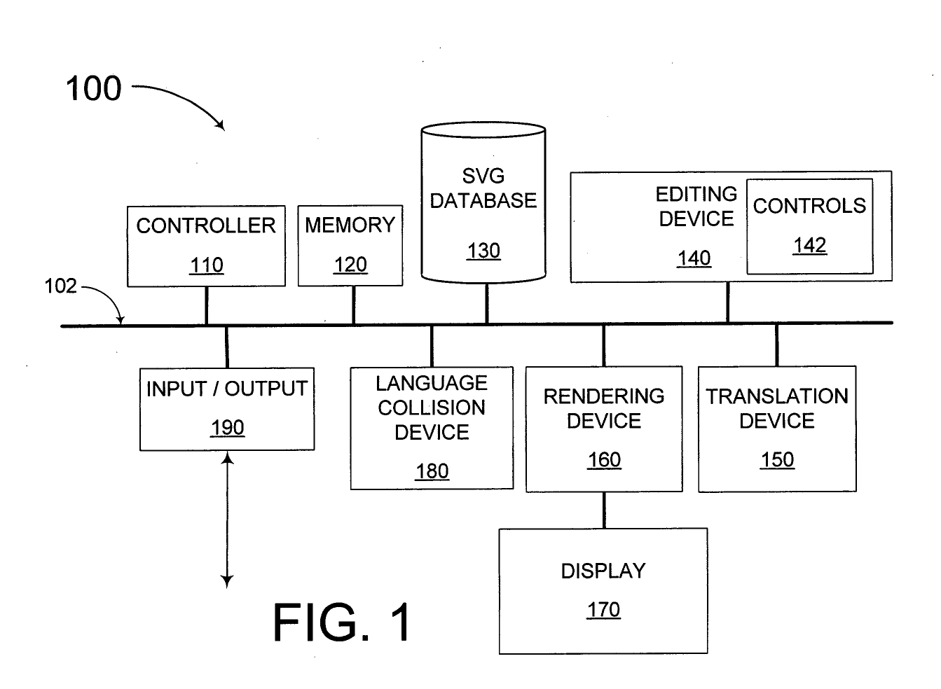

FIG. 1 is a graphic editor 100 capable of enabling an operator to generate, edit, render and display enterprise content. As shown in FIG. 1, the graphic editor 100 includes a controller 110, a memory 120, a Scalable Vector Graphics (SVG) database 130, an editing device 140 having a set of controls 142, a translation device 150, a rendering device 160 with display 170, a language collision detection device 180 and an input/output device 190. The various components 110-190 are coupled together with data/program bus 102

Although the exemplary graphic editor 100 of FIG. 1 uses a bussed architecture, it should be appreciated that any other architecture may be used as is well known to those of ordinary skill in the art. For example, in various embodiments, the various components 110-190 can take the form of separate electronic components coupled together via a series of separate busses.

Still further, in other embodiments, one or more of the various components 110-190 can take form of separate servers coupled together via one or more networks. Additionally, it should be appreciated that each of components 110-190 advantageously can be realized using multiple computing devices employed in a cooperative fashion. For example, by placing the SVG database into one server and networking multiple copies of the remaining components among a plurality of networked computers, a number of workstations allowing multiple independent operators to design different documents using a common database can be realized (or more importantly, the storage and transformation tasks can be shared among multiple servers, each dedicated to one aspect of the storage/retrieval process, allowing both large numbers of users to access the system, but also that the system can handle large libraries of both graphic objects and authored graphic scenes/diagrams).

It also should be appreciated that some of the above-listed components 130, 140, 150, 160 and 170 can take the form of software/firmware routines residing in memory 120 and be capable of being executed by the controller 110, or even software/firmware routines residing in separate memories in separate servers/computers being executed by different controllers. Further, it should be understood that the functions of any or all of components 140, 150, 160 and 170 can be accomplished using object-oriented software, thus increasing portability, software stability and a host of other advantages not available with non-object-oriented software.

In operation, an operator can evoke the editing device 140, and by viewing display 170 and manipulating the controls 142 can perform a variety of editing operations as is conceptually known in the art, such as call-up a graphic object, change the shape of the graphic object, place and orient the graphic object etc. The controls 142 of the present embodiment can include any number of well known or later developed real or virtual computer controls, such as keyboards, keypads, a mouse or trackball, a stylus with pressure-sensitive screen, virtual buttons, slides data-entry windows and so on. The display 170 can be any know or later developed device useful for displaying computer-based information, such as a computer screen or television screen.

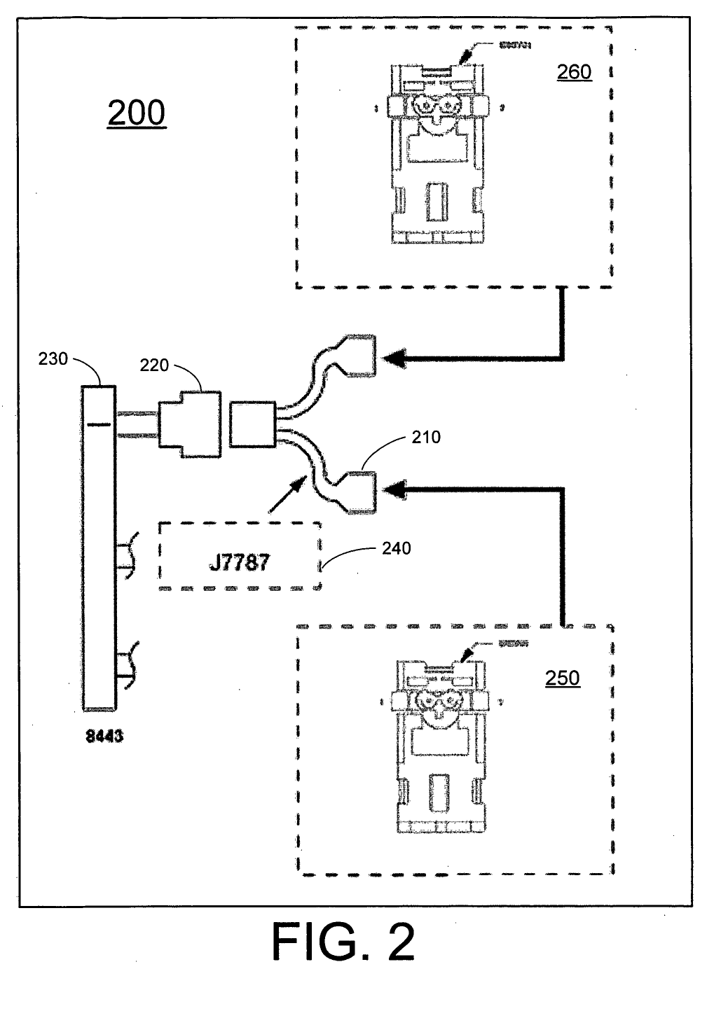

As the operator develops a graphic scene, a text file (not shown in FIG. 1) capable of describing the graphic scene can be generated and updated automatically and near simultaneously if desired. For example, FIG. 2 shows an exemplary graphic scene 200 containing a number of (representations of) graphic objects 210-230 and place-holders 250-260 oriented at various positions relative to one another. The computer code below is an XML-based textual stream that can be used to render the SVG graphic scene depicted in FIG. 2 above. Note, the code below is actual derived code that has had empty and extraneous fields removed from the XML stream to make it easer to read. However, the resulting stream below is still valid and would create the graphic of FIG. 2.

| | |
|---|---|
| 1. | <primitives> |

| | |
|---|---|
| 2. | <primitive basetype=“template” type=“template”> |

| | |
|---|---|
| 3. | <details> |

| | |
|---|---|
| 4. | <filename>8443a</filename> |

| | |
|---|---|
| 5. | </details> |

| | |
|---|---|
| 6. | </primitive> |

| | |
|---|---|
| 7. | <primitive basetype=“symbol” type=“symbol” |

attached_to=“container_symbol_2”>

| | |
|---|---|
| 8. | <details> |

| | |
|---|---|
| 9. | <filename>hb480007</filename> |
| 10. | <type/> |
| 11. | <x>140</x> |
| 12. | <y>279</y> |
| 13. | <scale>0.644</scale> |

| | |
|---|---|
| 14. | </details> |

| 15. | </primitive> |
|---|---|
| 16. | <primitive basetype=“text” type=“text” |
| | attached_to=“container_text_1”> |

| | |
|---|---|
| 17. | <details> |

| | |
|---|---|
| 18. | <text><![CDATA[J7787]]></text> |
| 19. | <align>start</align> |
| 20. | <wrap>N</wrap> |
| 21. | <x>64</x> |
| 22. | <y>237</y> |
| 23. | <scale>1</scale> |
| 24. | <text_width>26.5</text_width> |
| 25. | <text_height>7.31</text_height> |

| | |
|---|---|
| 26. | </details> |

| | |
|---|---|
| 27. | </primitive> |
| 28. | <primitive basetype=“symbol” type=“symbol” |

attached_to=“container_symbol_1”>

| | |
|---|---|
| 29. | <details> |

| | |
|---|---|
| 30. | <filename>hb480007</filename> |
| 31. | <type/> |
| 32 | <x>139.2</x> |
| 33. | <y>6.61</y> |
| 34. | <scale>0.676</scale> |
| 35. | </details> |

| | |
|---|---|
| 36. | </primitive> |

| | |
|---|---|
| 37. | </primitives> |

As can be seen above, the computer code can amount to essentially a number of reference pointers to graphic objects and related instructions. While the present code is written in XML, it should be appreciated that any existing or later developed computer language capable of incorporating reference pointers (filenames in the example above) and various instructions (e.g., scale) might alternatively be used or appropriately modified/enhanced to be used. For example, the hyper text markup language (html) standard might be modified in such a way as to incorporate scalable vector graphics, or a special pre-processing tool or process might be used in conjunction with html to render appropriately scaled graphic objects and text before such html code might actually operate upon such pre-processed objects and text.

In addition to SVG graphics, the editor 140 can place and manipulate individual “image symbols”/“image objects”. An image symbol/object can be very similar to an SVG symbol/object, except the image symbol/object is raster or bitmap information, as opposed to vector data. This functionality can be included to further enhance certain applications, such as product label publishing, since many of the elements within certain product labels (e.g., a baby food label) would more likely come from a rasterized bitmap image and not a vector. Any raster/bitmap objects can be stored in database 130 or a separate memory, and like SVG objects can be referenced, rather than stored, in a graphics file.

Returning to FIG. 1, as the operator works on a graphic scene and generates the appropriate XML-language graphics file, the text within the file can be manipulated by the translation device 150 to translate the textual data into a data form that the controller 100 (or other local processor) can understand, such as binary machine code. Translation can occur on-line or occur later as needed.

Next, the rendering device 160 can receive the translated graphics file and perform what is referred to as “delayed rendering”. From the graphically neutral XML representation of a piece of artwork, an SVG-based file can be created for either editing purposes (which would directly feed the editing device 140), or for viewing/printing purposes, in which a simple, non-interactive version can be rendered. These simple rendered versions can be sent to other systems and used directly for electronic display or print or as input to create bitmap versions of the graphics.

This delayed rendering feature allows for easier downstream changes, if it is decided that a systematic change is needed. A new rendering device can be constructed/written, or an existing one tweaked, and then the content of a graphics file can be re-rendered without having humans load and re-work the artwork, piece-by-piece. Such changes could include: changing font styles (faces, sizes, etc), changing the arrow heads on callouts, using different background on the artwork. adding a border etc.

The possible advantages are substantial. In the past, such systematic changes would mean the manual reworking of each piece of art to effect such changes. However, with the disclosed editing systems and methods, a re-rendering can be triggered without requiring human intervention.

In addition to the processes above, it can be advantageous to augment the graphics systems and methods disclosed above with a number of safeguards, for which the language collision detection device 180 is employed. Language collision detection can be either on-line/real-time or run off-line program in a batch environment. The language collision detection device 180 is useful for loading up multi-language diagrams and detecting collisions between text labels and graphics of all languages. This tool gives the multi-language proofing process a head-start in figuring out which diagrams need to be tweaked.

Note that this type of tool and processing is useful because of the unique nature of this application environment. For example, an author may be responsible for creating the English versions of a diagrams, but might have no interest in using the language features of the system to make the diagrams multi-language “friendly” in the first place. The author only cares about creating the initial English version and does not want to be “bothered” with positioning for more than that one language. While the system would allow one to do the editing in English, yet see the overall size or impact of other languages, the language collision device provides a time-saving alternative. A tool like this is useful to examine the original diagrams which were created in English, but could use some identification as a likely candidates for tweaking in the languages which must eventually be supported (but done by a different group than those who did the original version).

Another possible function of the language collision detection device 180 is “per item textual annotations” in which textual annotations can be assigned at both the individual element level, and the diagram level, allowing an on-going conversation about the contents of a diagram. This functionality can allow the storage, input and review of textual annotations for every element within a diagram. When the calling system sends userids along with the edit requests, this ID is recorded with all annotations (and all other editing actions) which allows a review of who did what to a diagram, as well as who said what about it, via the annotations.

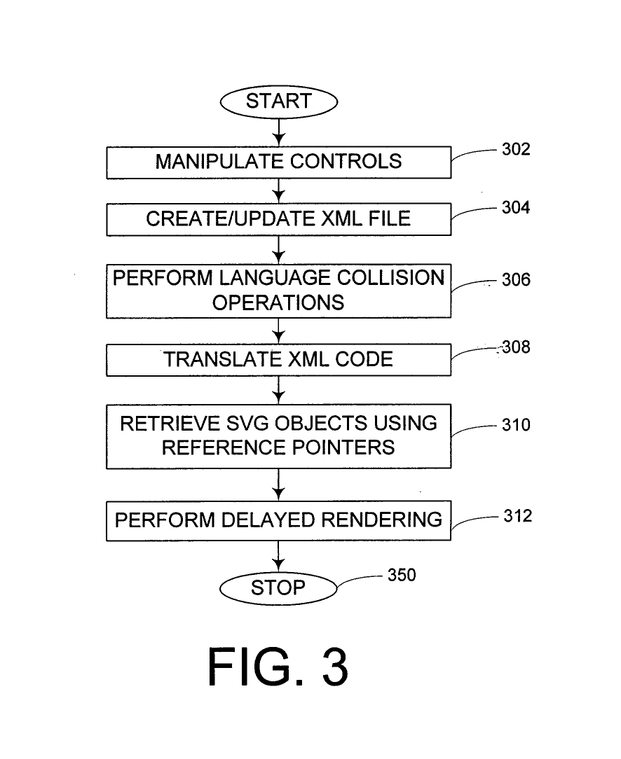

FIG. 3 is a flowchart outlining an exemplary operation for generating a graphic file and rendering a respective graphic scene. The process starts on step 302 where an operator manipulates a series of computer-based controls in order to generate a graphic scene on a display. Next, in step 304, a textual file is generated in response to the control manipulation of step 302. While the exemplary file of step 304 is an XML file, as mentioned above the particular language used can vary from embodiment to embodiment. Control continues to step 306.

In step 306, a series of language collision operations can be performed in order that no text/text boxes collide with other text/text boxes or collide with any graphic object. While step 306 is depicted as occurring “on-line”/“real time” in the context of the flowchart of FIG. 3, this step may be performed off-line or skipped altogether. Control continues to step 308.

In step 308, the XML graphics file generated in step 304 is translated into a local machine-dependant language. Next, in step 310, the various SVG objects referenced in the translated XML graphics file are retrieved from a database. Then, in step 312, a delayed graphic-rendering process is performed on the retrieved graphic objects. Control then continues to step 350 where the process stops.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the various disclosed systems and/or methods

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A computer-based apparatus for creating graphic designs based on a delayed-rendering technique using scalable vector graphics, the apparatus comprising:
a database containing a plurality of graphic objects, each object being a scalable vector graphic; and
an editing tool containing a plurality of graphics controls, wherein manipulation of the graphics controls causes the editing tool to create a graphic scene using the plurality of scalable vector graphic objects while manipulating a respective first set of instructions and reference pointers, each reference pointer pointing to a respective scalable vector graphic objects in the database.

2. The apparatus of claim 1, further comprising a translation device capable of translating the first set of instructions and reference pointers to a machine language.

3. The apparatus of claim 2, wherein the translator is an extended Markup Language (XML) translator, and the first set of instructions and reference pointers are XML-compliant.

4. The apparatus of claim 1, further comprising a graphics rendering device that performs a delayed rendering process by retrieving at least one scalable vector graphic object using a respective pointer in the first set of instructions and reference pointers.

5. The apparatus of claim 1, further comprising a graphics rendering device that performs a delayed rendering process by retrieving a plurality of respective scalable vector graphic objects using each and every pointer in the first set of instructions and reference pointers.

6. The apparatus of claim 1, wherein the first set of instructions and reference pointers contains no SVG objects.

7. The apparatus of claim 1, further comprising a language collision detection device configured to detect collisions between text labels and graphic objects based on the first set of instructions and reference pointers.

8. The apparatus of claim 7, wherein the language collision detection device is configured to detect collisions between text labels and graphic objects for a variety of alternative textual languages.

9. A method for creating graphic designs based on a delayed-rendering technique using scalable vector graphics, the method comprising:
performing a variety of editing operations using an editing tool containing a plurality of graphics controls, wherein manipulation of the graphics controls causes the editing tool to create a graphic scene using the plurality of scalable vector graphic objects while manipulating a respective first set of instructions and reference pointers, each reference pointer pointing to a respective scalable vector graphic objects in the database.

10. The method of claim 9, further comprising translating the first set of instructions and reference pointers to a machine language.

11. The apparatus of claim 10, wherein the first set of instructions and reference pointers is XML-compliant.

12. The method of claim 9, further comprising performing a delayed rendering process by retrieving at least one scalable vector graphic object from the database using a respective pointer in the first set of instructions and reference pointers.

13. The method of claim 9, further comprising performing a delayed rendering process by retrieving a plurality of respective scalable vector graphic objects from the database using each and every pointer in the first set of instructions and reference pointers.

14. The method of claim 9, wherein the first set of instructions and reference pointers contains no SVG objects.

15. The method of claim 9, further comprising performing a language collision detection process on the first set of instructions and reference pointers to detect collisions between text labels and graphic objects.

16. The method of claim 15, wherein the language collision detection process detects collisions between text labels and graphic objects for a variety of alternative textual languages.

17. A computer-based apparatus for creating graphic designs based on a delayed-rendering technique using scalable vector graphics, the apparatus comprising:
a database containing a plurality of objects, each object being a scalable vector graphic; and
an editing means for editing a graphic scene using a first set of instructions and reference pointers.

18. The apparatus of claim 17, further comprising a graphics rendering means for performing a delayed rendering process using the first set of instructions and reference pointers.

19. The apparatus of claim 1, further comprising a language collision detection means for off-line detection of collisions between text labels and graphic objects based on the first set of instructions and reference pointers.

20. The apparatus of claim 19, wherein the language collision detection device is configured to detect collisions between text labels and graphic objects for a variety of alternative textual languages.
